(19) United States
(12) Patent Application Publication
(10) Pub. No.: US 2006/0234085 A1
(43) Pub. Date: Oct. 19, 2006

(54) Bonded magnet and process for its manufacture

(75) Inventor: Mutsuko Nakano, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/389,243

(22) Filed: Mar. 27, 2006

(30) Foreign Application Priority Data
Mar. 29, 2005 (JP) P2005-095511

(51) Int. Cl. B32B 15/00

(52) U.S. Cl. 428/692.1; 148/301

(57) ABSTRACT

The invention provides a bonded magnet having more excellent rust inhibiting performance than the prior art, and a process for its manufacture. The bonded magnet manufacturing process of the invention is a process for manufacture of a bonded magnet wherein a protective layer is formed on the surface of a bonded magnet body containing a rare earth element, the process comprising a step of contacting the bonded magnet body with a solution containing a phosphate and an acid ion to form a phosphorus-containing protective layer on the surface of the bonded magnet body.

### BACKGROUND OF THE INVENTION

1. Field of the Invention

The present invention relates to a bonded magnet, and particularly a bonded magnet having a protective layer on its surface, as well as to a process for its manufacture.

2. Related Background Art

Conventional magnets comprising rare earth elements are known which are sintered magnets obtained by sintering of magnetic powder, or bonded magnets obtained by mixing magnetic powder with a binder resin and molding the mixture. Such magnets comprising rare earth elements are readily susceptible to rusting because of the relatively easily oxidized rare earth elements they contain as main components, and they therefore tend to have relatively low corrosion resistance. Consequently, the deterioration in performance of such magnets during manufacture and use is of great consideration.

In order to solve these problems, the corrosion resistance of sintered magnets is commonly improved by forming a corrosion-resistant protective layer on the surface by electrodeposition, or by forming a corrosion-resistant protective layer by application of a sol solution and heat treatment at 200° C. or above. However, it has been difficult to form protective layers on bonded magnets in the same manner as sintered magnets, because bonded magnets contain a binder resin which renders them unsuitable for electrodeposition, while the binder resin becomes degraded during the high-temperature heat treatment mentioned above.

As an alternative method for improving the corrosion resistance of bonded magnets, there are known methods of forming chemical conversion coatings on the surface by chemical conversion treatment. For example, Japanese Unexamined Patent Publication SHO No. 64-13707 discloses a resin-bonded magnet having the surface coated with a phosphate.

### SUMMARY OF THE INVENTION

However, even when such chemical conversion coating formation methods are applied, it has still been difficult to achieve bonded magnets with adequately improved corrosion resistance, and particularly rust inhibiting performance.

It is therefore an object of the present invention, which has been accomplished under the circumstances described above, to provide a bonded magnet with excellent rust inhibiting performance compared to the prior art, as well as a process for its manufacture.

As a result of much diligent research conducted with the aim of achieving the aforestated object, the present inventors have completed the present invention upon finding that by adding a prescribed additive to the chemical conversion treatment solution, it is possible to form a protective layer that confers more excellent corrosion resistance than by the prior art.

Specifically, the process for manufacture of a bonded magnet according to the invention is a bonded magnet manufacturing process wherein a protective layer is formed on a surface of a bonded magnet body containing a rare earth element, the process being characterized by comprising a step of contacting the bonded magnet body with a solution containing a phosphate and an acid ion to form a phosphorus-containing protective layer on the surface of the bonded magnet body.

In the bonded magnet manufacturing process of the invention, then, an acid ion is added as an additive in an aqueous solution (chemical conversion treatment solution) containing a phosphate. The phosphorus-containing protective layer formed in this manner can exhibit more excellent corrosion resistance than a chemical conversion coating of the prior art.

While the reason for this result is not fully understood, the present inventors conjecture as follows. That is, during formation of a chemical conversion coating on the surface of a magnet body, the metal in the magnet body dissolves as an ion in the chemical conversion treatment solution and the eluted metal ion reacts with phosphate ion at metal dissolved region. This is believed to be the mechanism of the protective layer formation. When a protective layer is formed by this mechanism, the presence of an acid ion in the chemical conversion treatment solution as according to the present invention produces effects whereby the acid ion oxidizes the metal ion eluted in the chemical conversion treatment solution and removes it out of the system, while also accelerating elution of the metal into the chemical conversion treatment solution. This causes the protective layer forming reaction to be favored, resulting in formation of a satisfactory protective layer.

The acid ion concentration in the solution for the bonded magnet manufacturing process of the invention is preferably 0.75 mmol/L or greater. This will tend to provide further advantages in forming the protective layer.

More specifically, the acid ion is preferably at least one species of ion selected from the group consisting of nitrous acid ion, sulfurous acid ion and acetic acid ion. These acid ions have excellent properties among those mentioned above and can be conveniently added to the chemical conversion treatment solution. Consequently, adding such acid ions to the chemical conversion treatment solution can easily result in formation of a protective layer with high corrosion resistance.

The bonded magnet of the invention is provided with a bonded magnet body containing a rare earth element and a protective layer containing Zn and P formed on a surface of the magnet body, and is characterized in that the ratio M_{Zn}/M_{P} of the Zn weight M_{Zn} and P weight M_{P} in the protective layer satisfies the conditions represented by the following inequality (1).
2.4≦M_{Zn}/M_{P}≦7.8 (1)

A protective layer satisfying these conditions can be satisfactorily formed by the bonded magnet manufacturing process of the invention as described above. A bonded magnet provided with such a protective layer exhibits more excellent corrosion resistance than the prior art.

### BRIEF DESCRIPTION OF THE DRAWINGS

FIG. 1 is a perspective view of an embodiment of a bonded magnet of the invention.

FIG. 2 is a schematic view of the cross-sectional structure along line II-II of the bonded magnet shown in FIG. 1.

### DESCRIPTION OF THE PREFERRED EMBODIMENTS

A preferred embodiment of the invention will now be explained with reference to the accompanying drawings. Throughout the drawings, corresponding elements will be indicated by like reference numerals and will be explained only once.

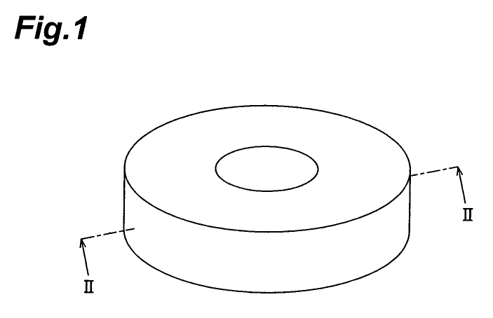

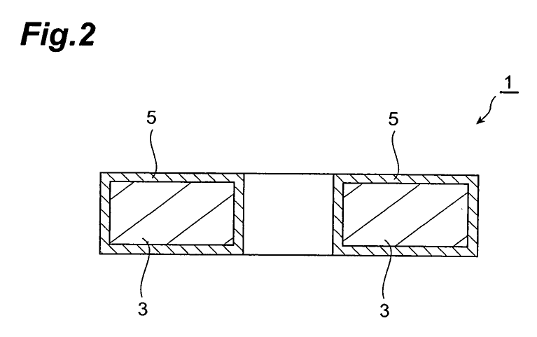

First, the structure of a bonded magnet according to an embodiment of the invention will be explained with reference to FIGS. 1 and 2.

FIG. 1 is a perspective view of a bonded magnet according to the embodiment. FIG. 2 is a schematic view of the cross-sectional structure along line II-II of the bonded magnet shown in FIG. 1. As seen in these drawings, the bonded magnet 1 has a structure provided with a magnet body 3 (bonded magnet body) and a protective layer 5 formed covering its surface.

The magnet body 3 comprises a rare earth element-containing magnetic powder and a binder resin, and its magnetic powder is bonded by the binder resin. The rare earth metal-containing magnetic powder is not particularly restricted so long as it is one that is commonly employed as a starting material for rare earth metal magnets, and powders containing Sm or Nd as rare earth elements may be mentioned. More specifically, there may be mentioned Sm—Co based magnetic powders, Nd—Fe—B based magnetic powders and Sm—Fe—N based magnetic powders.

Among the magnetic powders mentioned above, there are preferred Sm—Co based magnetic powders such as SmCo₅ and Sm₂Co₁₇, and Nd—Fe—B based magnetic powders such as Nd₂Fe₁₄B. These magnetic powders are able to exhibit excellent magnetic properties after formation of the bonded magnet 1. Magnetic powder with a mean particle size (long axis) of 100-200 μm and a maximum particle size of no greater than 500 μm is particularly preferred in order to obtain satisfactory magnetic properties.

The binder resin used may be a thermosetting resin or thermoplastic resin capable of bonding between the magnetic powder. As such binder resins there may be mentioned thermosetting resins such as epoxy resins and phenol resins, or thermoplastic resins such as styrene-based, olefin-based, urethane-based, polyester-based and polyamide-based elastomers, ionomers, ethylene-propylene copolymer (EPM) and ethylene-ethyl acrylate copolymer. Thermosetting resins are preferred among these, with epoxy resins or phenol resins being especially preferred.

The magnet body 3 preferably contains the magnetic powder and binder resin in the following mixing ratio. That is, the magnetic powder is preferably present in the magnet body 3 at 95 parts by mass or greater with respect to 100 parts by mass as the total of the magnetic powder and binder resin. If the magnetic powder content is less than 95 parts by mass, the magnetic properties of the bonded magnet 1 will tend to be reduced. From the standpoint of sufficient bonding of the magnetic powder, however, the binder resin is preferably included in an amount of at least 1.5 parts by mass.

The magnet body 3 may further contain, in addition to the aforementioned magnetic powder and binder resin, also a metal soap such as zinc stearate or a titanate-based or silane-based coupling agent or the like.

The protective layer 5 is a phosphorus-containing layer formed on the surface of the magnet body 3 containing the rare earth element, and it has the function of reducing the influence of outside air (oxygen, humidity, etc.) on the magnet body 3. The protective layer 5 is a chemical conversion coating formed by subjecting the magnet body 3 to chemical conversion treatment in the manner described hereunder. The protective layer 5 is preferably a layer comprising a metal phosphate, and more preferably a layer composed mainly of a metal phosphate. As examples of such metal phosphates there may be mentioned zinc phosphate, manganese phosphate, iron phosphate and calcium zinc phosphate.

The protective layer 5 is preferably a layer comprising phosphorus (P) and zinc (Zn), and specifically it is more preferably a layer comprising zinc phosphate. Such a protective layer 5 can confer excellent corrosion resistance to the bonded magnet 1. As a zinc phosphate compound there may be mentioned Zn₃(PO₄)₂.4H₂O, but the protective layer 5 may comprise phosphorus or zinc in a different chemical composition.

When the protective layer 5 is a layer containing zinc phosphate, the Zn weight M_{Zn} and P weight M_{P} in the layer 5 are preferably in the relationship represented by inequality (1) below. The phosphorus and zinc in the protective layer 5 can be quantified using a laser ablation ICP mass spectrometer (LA-ICP-MS).
2.4≦M_{Zn}/M_{P}≦7.8 (1)

If the value of M_{Zn}/M_{P} in the protective layer 5 is outside of this range, the improving effect on corrosion resistance by the protective layer 5 will tend to be lower than when the value is within the range. From the standpoint of achieving a more satisfactory corrosion resistance improving effect, the value of M_{Zn}/M_{P} is more preferably between 4.5 and 6.0.

A process for manufacturing a bonded magnet 1 having the construction described above will now be explained.

First, an alloy having a prescribed composition for formation of the rare earth element-containing magnetic material is produced by a process such as casting or strip casting. The obtained alloy is subjected to crude pulverization with a crude pulverizer such as a jaw crusher, braun mill or stamp mill, and then to fine pulverization with a fine pulverizer such as a jet mill or attritor, to obtain magnetic powder having a suitable particle size.

The obtained magnetic powder is mixed with the binder resin and a curing agent or the like and then the mixture is loaded into a kneading machine such as a pressurizing kneader for kneading. The kneaded product is then compression molded with a compression molding machine or the like. Compression molding in a magnetic field allows polarization to be accomplished at the same time. Polarization may also be carried out separately after compression molding. From the standpoint of obtaining a magnet body 3 with excellent magnetic properties, the compression molding is preferably carried out at a high pressure of about 784-980 MPa, 8-10 t/cm².

After subsequent compression molding if the binder resin used is a thermosetting resin, the obtained molded article is heated at about 100-250° C. This hardens the binder resin to obtain a magnet body 3. When the binder resin used is a thermoplastic resin, such thermosetting is not necessary.

Next, the magnet body 3 is cleaned by spraying a solvent such as ethanol onto the magnet body 3, in order to remove excess magnetic powder or oils adhering to the surface of the magnet body 3. The solvent is not particularly restricted and may be a solvent other than ethanol, so long as it has an adequate cleaning function and does not affect the binder resin or other components in the magnet body 3. Ultrasonic cleaning may be performed instead of cleaning by solvent spraying. These methods may also be used together. After cleaning, the solvent remaining on the surface of the magnet body 3 is removed by natural drying or heated drying.

The cleaned magnet body 3 is then subjected to a surface modification step to facilitate the later chemical conversion treatment. Specifically, by immersing the magnet body 3 in a solution containing colloidal particles of a titanium salt such as titanium phosphate, for example, the colloidal particles are caused to adhere to the surface of the magnet body 3. The sections to which the colloidal particles have adhered constitute active points to facilitate subsequent chemical conversion treatment. The immersion may be carried out under reduced pressure so that the colloidal particles adhere into the interior of the magnet body 3.

Next, the magnet body 3 is subjected to chemical conversion treatment by immersion in a solution containing phosphoric acid and an acid ion (chemical conversion treatment solution), forming a protective layer made of a phosphorus-containing chemical conversion coating on the surface of the magnet body 3, to obtain a bonded magnet 1. The obtained bonded magnet 1 is then cleaned with ion-exchanged water to remove the chemical conversion treatment solution adhering to the surface, after which it is dried at 85° C. for about 30 minutes to complete the treatment. Thus is obtained a bonded magnet 1 having the structure shown in FIGS. 1 and 2.

The chemical conversion treatment solution used for chemical conversion treatment may be prepared, for example, by adding the acid ion metal salt to the metal phosphate-containing solution to dissolve the components. The chemical conversion treatment solution obtained in this manner may also contain ions such as PO₄³⁻, Zn²⁺ and acid ions. In the magnet body 3 immersed in the chemical conversion treatment solution, the metal (for example, Fe) in the structural material of the magnet body 3 reacts with the phosphoric acid and dissolves in the chemical conversion treatment solution. Also, zinc ions and phosphoric acid ions react on the surface generated by the dissolution, producing zinc phosphate. This reaction occurs on regions of the surface of the magnet body 3 where the magnetic powder is not covered by the binder resin.

The acid ion in the chemical conversion treatment solution is preferably nitrous acid ion, sulfurous acid ion, acetic acid ion, adipic acid ion or the like. Of these, nitrous acid ion is preferred in order to simplify processing of the chemical conversion treatment solution after use. When these acid ions are added as metal salts, the cation components of the metal salts are preferably Ni²⁺, Mn²⁺, Na⁺, Ca²⁺, Fe²⁺ or Ce²⁺. More specifically, preferred metal salts of acid ions added to the chemical conversion treatment solution include sodium nitrite, ammonium adipate, sodium acetate, nickel acetate, manganese sulfate and cerium sulfate.

In the chemical conversion treatment solution, the acid ion concentration is preferably 0.75 mmol/L or greater, more preferably 1.5 mmol/L or greater and even more preferably 2.25 mmol/L or greater. If the acid ion concentration of the chemical conversion treatment solution is less than 0.75 mmol/L, the effect of acid ion addition for improved corrosion resistance may be insufficient. If the acid ion concentration is too high, the sludge generation volume may rise, increasing the burden of waste water processing after treatment. Therefore, the acid ion concentration of the chemical conversion treatment solution is preferably no greater than 4.5 mmol/L.

The temperature of the chemical conversion treatment solution for chemical conversion treatment is preferably 40-90° C., and more preferably 50-80° C. If the temperature for chemical conversion treatment is below 50° C., dissolution of each of the components in the chemical conversion treatment solution may be reduced, tending to hamper efforts to form a protective layer 5 with sufficient properties.

The chemical conversion treatment time is preferably about 5-30 minutes. A chemical conversion treatment time of shorter than 5 minutes will tend to prevent formation of a protective layer 5 of adequate thickness. A time of longer than 30 minutes, on the other hand, lengthens the time required for the chemical conversion treatment step, resulting not only in increased cost for manufacture but also inviting evaporation of the chemical conversion treatment solution, a major inconvenience that can alter the concentration of the solution.

The conditions including the acid ion concentration and temperature of the chemical conversion treatment solution and the chemical conversion treatment time will tend to depend on each other. Specifically, in the case of a large acid ion concentration, for example, the chemical conversion treatment solution temperature may be lower and the chemical conversion treatment time may be shorter, or in the case of a high chemical conversion treatment solution temperature, the acid ion concentration may be lower and the chemical conversion treatment time may be shorter. Thus, these three conditions for the chemical conversion treatment may be appropriately adjusted in consideration of their interdependence, so as to form a protective layer 5 with the desired properties.

For example, the temperature and acid ion concentration for the chemical conversion treatment are preferably 50-80° C. as the temperature and 0.75-3.75 mmol/L as the acid ion concentration. At a temperature of 50-70° C., the acid ion concentration is more preferably 1.5-2.25 mmol/L.

The process for manufacture of such a bonded magnet 1, wherein an acid ion is present in the chemical conversion treatment solution as described above, therefore yields a satisfactory protective layer 5 on the surface of the magnet body 3. Thus, a bonded magnet 1 having a protective layer 5 formed in such a manner exhibits excellent corrosion resistance compared to one obtained using a chemical conversion treatment solution containing no acid ion.

The bonded magnet of the invention and the process for its manufacture are not necessarily limited to the embodiment described above. For example, while contact of the chemical conversion treatment solution with the magnet body 3 was achieved by immersion of the magnet body 3 in the chemical conversion treatment solution according to this embodiment, this mode is not limitative. Alternatively, the chemical conversion treatment solution may be contacted with the magnet body 3 by, for example, coating or spraying.

The chemical conversion treatment need not be carried out by immersing the magnet body 3 in a chemical conversion treatment solution already containing both a phosphate and an acid ion. For example, the magnet body 3 may be first immersed in a chemical conversion treatment solution containing a phosphate, and then the acid ion added to the chemical conversion treatment solution in which the magnet body 3 is immersed.

### EXAMPLES

The present invention will now be explained in further detail by examples, with the understanding that the invention is in no way limited to these examples.

[Manufacture of Bonded Magnet]

### Examples 1-14, Comparative Examples 1-4

An alloy comprising 72 wt % Fe, 19 wt % Nd and 7 wt % B was prepared and pulverized to obtain magnetic powder. This magnetic powder was mixed with an epoxy resin as a binder resin, and the mixture was compression molded under a pressure of 980 MPa and then heat treated at 150° C. for curing of the binder resin, to obtain a magnet body. The obtained magnet body was subsequently cleaned with ethanol and dried, and then immersed in a colloidal solution of titanium phosphate under reduced pressure for surface modification treatment.

Next, the magnet body was immersed in a chemical conversion treatment solution comprising zinc phosphate and the different additives listed in Table 1, and chemical conversion treatment was carried out according to the chemical conversion treatment solution temperatures and chemical conversion treatment times listed in Table 1 to form protective layers composed of chemical conversion coatings on the surfaces of the magnet bodys, thereby obtaining bonded magnets. The amount of additive in each chemical conversion treatment solution was adjusted to produce acid ion concentrations in the chemical conversion treatment solutions as listed in Table 1.

The obtained bonded magnet was then cleaned with ion-exchanged water and dried at 85° C. for 30 minutes for completion of bonded magnets for Examples 1-14 and Comparative Examples 1-4.

[Evaluation of Rust Inhibiting Performance]

There were produced ten each of the bonded magnets of Examples 1-14 and Comparative Examples 1-4, and these were allowed to stand for 500 hours in a high-temperature, high-humidity environment of 60° C., 95% RH. Next, the surfaces of all of the bonded magnets were observed with a microscope (20×), and the presence or absence of rust was confirmed. The number of samples without rusting (hereinafter referred to as “satisfactory products”) among the ten samples of each of the examples and comparative examples was counted. The proportion of satisfactory products obtained (satisfactory product yield, %) among the bonded magnets of the examples and comparative examples was calculated based on the result. The data are shown in Table 1.

TABLE 1

| | | | | | Satisfactory |
|---|---|---|---|---|---|
| | Treatment | Treatment | | Additive | product |
| | temperature | time | | concentration | yield |
| | (° C.) | (min) | Additive | (mmol/L) | (%) |
| Comp. Ex. 1 | 50 | 10 | none | 0 | 30 |
| Example 1 | 50 | 10 | sodium nitrite | 2.25 | 50 |
| Example 2 | 50 | 10 | sodium nitrite | 3.75 | 50 |
| Comp. Ex. 2 | 50 | 30 | none | 0 | 60 |
| Example 3 | 50 | 30 | sodium nitrite | 2.25 | 100 |
| Comp. Ex. 3 | 70 | 10 | none | 0 | 60 |
| Example 4 | 70 | 10 | sodium nitrite | 0.75 | 70 |
| Example 5 | 70 | 10 | sodium nitrite | 1.5 | 100 |
| Example 6 | 70 | 10 | sodium nitrite | 2.25 | 100 |
| Comp. Ex. 4 | 80 | 10 | none | 0 | 80 |
| Example 7 | 80 | 10 | sodium nitrite | 2.25 | 80 |
| Example 8 | 80 | 10 | sodium nitrite | 3.75 | 100 |
| Example 9 | 70 | 10 | sodium sulfite | 2.25 | 100 |
| Example 10 | 70 | 10 | diammonium | 2.25 | 100 |
| | | | adipate | | |
| Example 11 | 70 | 10 | sodium acetate | 2.25 | 80 |
| Example 12 | 70 | 10 | nickel acetate | 2.25 | 80 |
| Example 13 | 70 | 10 | manganese(II) | 2.25 | 70 |
| | | | sulfate | | |
| Example 14 | 70 | 10 | cerium(IV) | 2.25 | 60 |
| | | | sulfate | | |

Table 1 shows that, given the same chemical conversion treatment temperature, a higher product yield was obtained with the bonded magnets of the examples which were produced by including an additive in the chemical conversion treatment solution, compared to the bonded magnets of the comparative examples which were produced without additives. Also, it was confirmed that a higher satisfactory product yield is achieved with a higher treatment temperature, within the range of this experiment.

Furthermore, while a reasonably acceptable satisfactory product yield was achieved without an additive when the chemical conversion treatment solution temperature was high (70° C. or above), a lower chemical conversion treatment solution temperature (50° C.) did not produce a sufficient satisfactory product yield without an additive. This demonstrated that addition of an additive can result in production of a bonded magnet with an excellent satisfactory product yield even with a low chemical conversion treatment solution temperature.

[Analysis of Protective Layer]

As a result of microscopic observation of the surfaces of the bonded magnets of Examples 1-3,5-8 and Comparative Examples 1-4, the surfaces of the protective layers were found to have regions containing silver magnetic powder and regions containing yellow magnetic powder. The silver magnetic powder regions, yellow magnetic powder regions and corner sections of each of the bonded magnets were analyzed with a laser ablation ICP mass spectrometer (LA-ICP-MS, Laser part: LUV266X by New Wave Research, ICP-MS part: Agilent 7500S by Yokokawa Analytical Systems, Laser conditions: 20 μm wavelength, 10 Hz frequency) for quantification of the Zn weight (M_{Zn}) and P weight (M_{P}) in each region. The M_{Zn}/M_{P} values for each region were calculated from the results. The data are shown in Table 2.

TABLE 2

| | M_{Zn}/M_{P} | | |
|---|---|---|---|
| | Silver magnetic | Yellow magnetic | |
| | powder region | powder region | Corner section |
| Comp. Ex. 1 | 2.0 | 1.8 | 1.2 |
| Example 1 | 2.0 | 1.4 | 2.2 |
| Example 2 | 2.6 | 2.2 | 1.8 |
| Comp. Ex. 2 | 2.1 | 1.8 | 1.6 |
| Example 3 | 5.7 | 5.7 | 2.4 |
| Comp. Ex. 3 | 1.3 | 1.3 | 1.1 |
| Example 5 | 5.0 | 7.8 | 2.5 |
| Example 6 | 4.5 | 6.0 | 2.5 |
| Comp. Ex. 4 | 1.7 | 1.7 | 1.7 |
| Example 7 | 2.0 | 2.1 | 2.1 |
| Example 8 | 2.4 | 2.4 | 2.4 |

Table 2 shows that for the bonded magnets of the examples, which were obtained with inclusion of an additive to the chemical conversion treatment solution, the M_{Zn}/M_{P} values were all in the range of 2.4-7.8. Thus, it was demonstrated that a protective layer having a M_{Zn}/M_{P} value in this range results in excellent corrosion resistance.

As explained above, the present invention can provide a bonded magnet having more excellent rust inhibiting performance than the prior art, as well as a process for its manufacture.

1. A process for manufacture of a bonded magnet wherein a protective layer is formed on a surface of a bonded magnet body containing a rare earth element comprising:
a step of contacting said bonded magnet body with a solution containing a phosphate and an acid ion to form a phosphorous-containing protective layer on the surface of said bonded magnet body.

2. A process for manufacture of a bonded magnet according to claim 1, wherein said solution contains said acid ion in a concentration of 0.75 mmol/L or greater.

3. A process for manufacture of a bonded magnet according to claim 1, wherein said acid ion is at least one species of ion selected from the group consisting of nitrous acid ion, sulfurous acid ion and acetic acid ion.

4. A bonded magnet comprising a bonded magnet body containing a rare earth element and a protective layer containing Zn and P formed on a surface of the magnet body,
wherein the ratio M_{Zn}/M_{P} of the Zn mass M_{Zn} and P mass M_{P} in the protective layer satisfies the conditions represented by the following inequality (1).
2.4≦M_{Zn}/M_{P}≦7.8 (1)

5. A process for manufacture of a bonded magnet according to claim 2, wherein said acid ion is at least one species of ion selected from the group consisting of nitrous acid ion, sulfurous acid ion and acetic acid ion.
